(19) United States
(12) Patent Application Publication
(10) Pub. No.: US 2010/0125365 A1
(43) Pub. Date: May 20, 2010

(54) REFRIGERATOR AND METHOD OF CONTROLLING SAME

(75) Inventors: Kwang Woon AHN, Seoul (KR); Gye Young SONG, Seoul (KR); Kyung Seok KIM, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 12/429,339

(22) Filed: Apr. 24, 2009

(30) Foreign Application Priority Data
Nov. 19, 2008 (KR) 10-2008-0115144

(51) Int. Cl. G05B 15/00; F25D 17/08; F25B 19/00; F24F 13/10

(52) U.S. Cl. 700/275; 62/419; 62/231; 454/333

(57) ABSTRACT

A refrigerator is provided. The refrigerator may include a freezing chamber positioned under a refrigerating chamber. A refrigerating chamber fan and a freezing chamber fan may be provided at a refrigerating chamber duct and a freezing chamber duct, respectively, and a damper may selectively open and close the refrigerating chamber duct. By controlling the refrigerating chamber fan, the freezing chamber fan and the damper, cold air may be selectively supplied to the refrigerating chamber and/or the freezing chamber based on individual cooling needs as appropriate.

### CROSS REFERENCE TO RELATED APPLICATION

This application claims the benefit of Korean Patent Application No. 10-2008-0115144, filed in Korea on Nov. 19, 2008, the entirety of which is incorporated herein by reference.

### BACKGROUND

1. Field

A refrigerator is provided, and in particular, a refrigerator having a refrigerating chamber and a freezing chamber is provided.

2. Background

In general, a refrigerator may be provided with a compressor, a condenser, an expansion valve, an evaporator, and other such refrigerating cycle components which together provide for the discharge of cold air into a refrigerating chamber and a freezing chamber so as to control temperatures thereof. Depending on relative positions of the refrigerating chamber and the freezing chamber, refrigerators may include a top mount-type refrigerator in which the freezing chamber is positioned over the refrigerating chamber, a side by side type refrigerator in which the freezing chamber and the refrigerating chamber are positioned side by side, and numerous other arrangements as appropriate. The evaporator and a fan may be provided at a rear portion of the refrigerator for blowing cold air into the freezing chamber and the refrigerating chamber.

### BRIEF DESCRIPTION OF THE DRAWINGS

The embodiments will be described in detail with reference to the following drawings in which like reference numerals refer to like elements wherein:

FIG. 1 is a front perspective view of an exemplary refrigerator in accordance with embodiments as broadly described herein;

FIG. 2 is a perspective view of a cold air supply structure of the refrigerator shown in FIG. 1;

FIG. 3 is a block diagram of a control system of the exemplary refrigerator shown in FIG. 1; and

FIG. 4 is a flow chart of a method for controlling a refrigerator as embodied and broadly described herein.

### DETAILED DESCRIPTION

Reference will now be made in detail to specific embodiments, examples of which are illustrated in the accompanying drawings. Wherever possible, the same reference numbers will be used throughout the drawings to refer to the same or like parts.

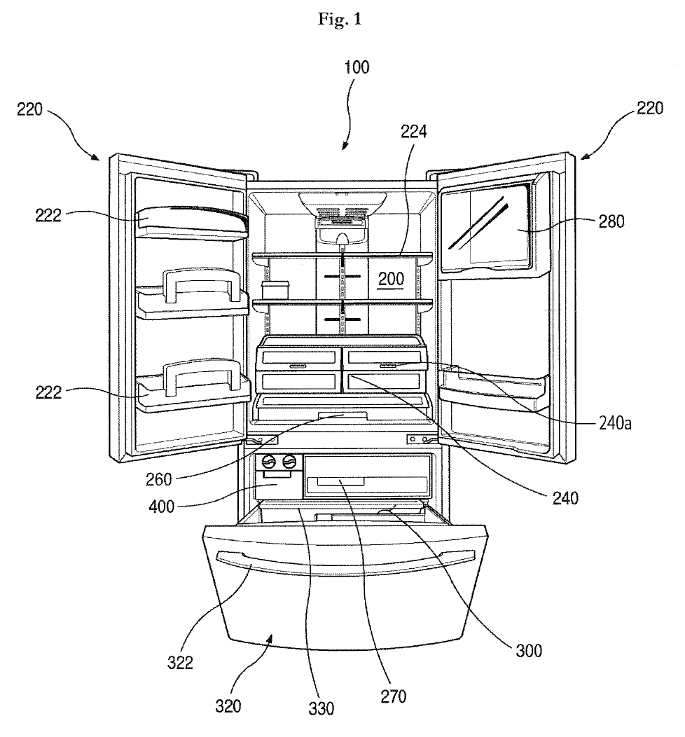

The exemplary refrigerator shown in FIG. 1 is a bottom freezer type refrigerator having a rectangular storage space partitioned by a barrier into an upper space and a lower space. However, embodiments as broadly described herein may be applied to other types of refrigerators having numerous different arrangements of refrigerating and freezing chambers.

In the refrigerator 100 shown in FIG. 1, the upper space is used for a refrigerating chamber 200 for the cold storage of food, and the lower space is used for a freezing chamber 300 for the frozen storage of food. The refrigerating chamber 200 has an open front that is opened/closed by one or more rotatably mounted refrigerating chamber doors 220. The refrigerating chamber doors 220 may each include a rear, or interior facing side, having a plurality of refrigerating chamber baskets 222 for storing food, drinks, and the like, and a front that provides access to a dispenser 280 for dispensing ice or water without opening the refrigerating chamber door 220.

The refrigerating chamber 200 may have an inside space partitioned by a plurality of refrigerating chamber shelves 224. The refrigerating chamber 200 may include a fresh food chamber 240 for storage of organic/fresh farm food that requires more precise temperature and/or humidity control, and a multipurpose wide chamber 260. Temperature of the chambers 240 and 260 may be controlled individually. The fresh food chamber 240 may include a plurality of LEDs 240a or other light source for emitting light of various colors respectively associated with a light of a color suitable to the food stored therein to ensure fresh storage of the food stored therein.

The freezing chamber 300 under the refrigerating chamber 200 may include a slidable drawer 320 that is movable in front/rear directions. The freezing chamber 300 may also include a sub-drawer 330. The user may open/close the freezing chamber 300 by grasping a handle 322 and pushing/pulling the drawer 320. Though not shown, the freezing chamber 300 may include rolling members on opposite sides of an inside wall thereof to provide for smooth sliding of the drawer 320.

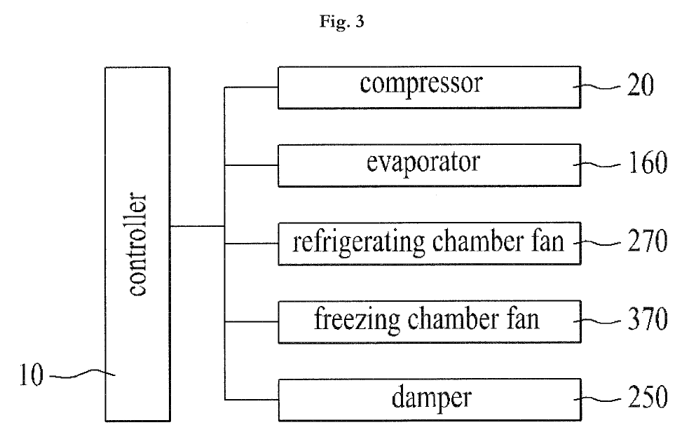

A compressor 20 (see FIG. 3) for compressing refrigerant, an evaporator 160 and a cold air generating room 600 for generating cold air may be positioned, for example, at a rear of the freezing chamber 300. The cold air, which is generated as air exchanges heat with the evaporator 160, is introduced into the refrigerating chamber 200 through a refrigerating chamber duct 230, and supplied to the freezing chamber 300 through a freezing chamber duct 370.

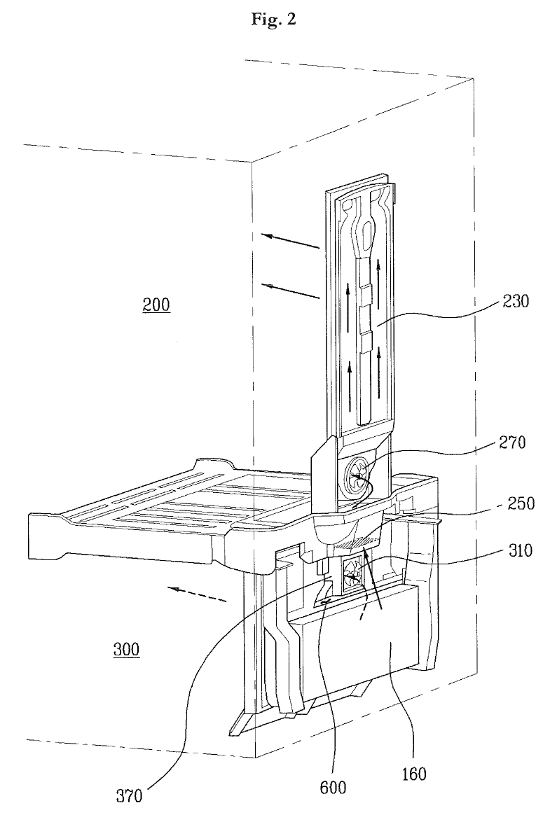

FIG. 2 illustrates a structure for blowing the cold air generated in the cold air generating room 600 into the refrigerating chamber 200 or the freezing chamber 300 in more detail. In the embodiment shown in FIG. 2, the refrigerating chamber 200 is positioned over the freezing chamber 300, and the cold air generating room 600 is positioned to a rear of the freezing chamber 300. The evaporator 160 receives compressed refrigerant from the compressor 20, and performs a heat exchange operation with surrounding air as the refrigerant evaporates, thus cooling the surrounding air.

A freezing chamber fan 310 may be provided at the freezing chamber duct 370. By operating the freezing chamber fan 310, cold air is forcibly blown into the freezing chamber 300 from the cold air generating room 600. The refrigerating chamber duct 230 may have a refrigerating chamber fan 270 and a damper 250 mounted thereto. Similarly, by operating the refrigerating chamber fan 270, cold air is forcibly blown into the refrigerating chamber 200 from the cold air generating room 600.

The damper 250 may selectively open and close the refrigerating chamber duct 230 under the control of a controller 10. Therefore, if it is intended to supply cold air to the refrigerating chamber 200, the controller 10 opens the damper 250, and operates the refrigerating chamber fan 270. If it is intended to supply cold air only to the freezing chamber 300, the controller 10 closes the refrigerating duct 230 with the damper 250, and operates the freezing chamber fan 310. Thus, if it is intended to supply the cold air mainly to the refrigerating chamber 200, the controller 10 opens the damper 250, and operates the refrigerating chamber fan 270, while maintaining the freezing chamber fan 310 in an off-state. If it is intended to supply the cold air both to the refrigerating chamber 200 and the freezing chamber 300, the controller 10 opens the damper 250 to open the refrigerating chamber duct 230, and operates both the refrigerating chamber fan 270 and the freezing chamber fan 310. In this instance, rotation speeds of the refrigerating chamber fan 270 and/or the freezing chamber fan 310 may vary with cold air demands from the refrigerating chamber 200 and the freezing chamber 300.

When the refrigerating chamber 200 or the freezing chamber 300 requires cold air, the compressor 20 may be kept operating. Thus, referring to FIG. 3, in order to supply cold air to the refrigerating chamber 200 and/or the freezing chamber 300, the controller 10 controls the compressor 20, the evaporator 160, the refrigerating chamber fan 270, the freezing chamber fan 310, and the damper 250 as appropriate.

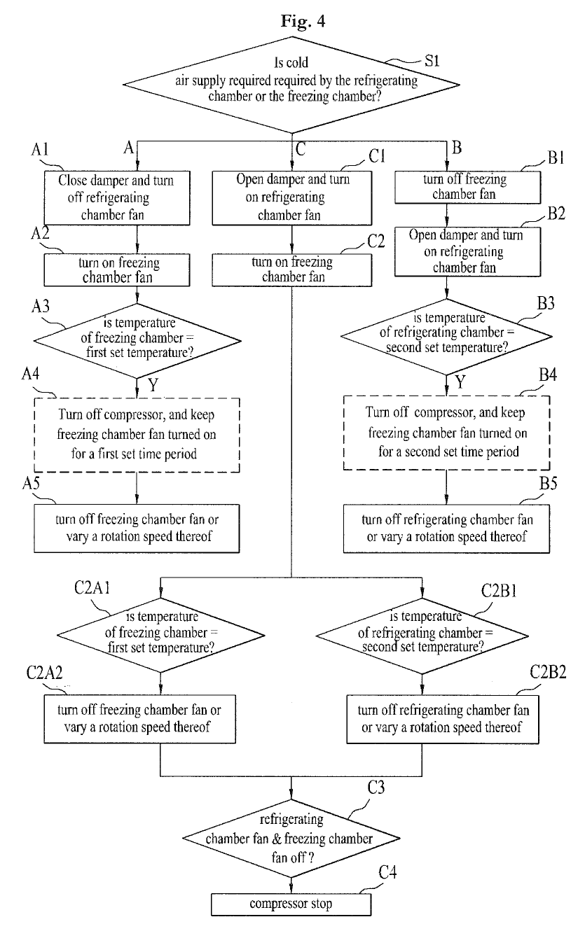

FIG. 4 is a flow chart of an exemplary method for supplying cold air to the refrigerating chamber 200 and/or the freezing chamber 300.

First, the controller 10 determines whether supply of cold air to the refrigerating chamber 200 or the freezing chamber 300 is required (S1). Then, based on a result of the determination made at step S1, the controller 10 follows a relevant control method. More specifically, the controller follows a path A for supplying the cold air only to the freezing chamber 300, a path B for supplying the cold air mainly to the refrigerating chamber 200, or a path C for supplying the cold air both to the refrigerating chamber 200 and the freezing chamber 300.

First, a case in which cold air is supplied to the freezing chamber 300 and not to the refrigerating chamber 300 (A) will be described.

The case in which cold air is supplied only to the freezing chamber 300 is typically a case in which a temperature of the refrigerating chamber 200 is at or below an acceptable refrigerating temperature, and thus cold air supply to the refrigerating chamber 200 is not required. Accordingly, introduction of cold air into the refrigerating chamber 200 is blocked by controlling the damper 250 to close the refrigerating chamber duct 230 and leaving the refrigerating chamber fan 270 turned off (A1). The freezing chamber fan 310 operates so as to blow cold air into the freezing chamber 300 (A2). In this instance, if a temperature of the freezing chamber 300 reaches a first set temperature, or enters into a first set temperature range (A3), the freezing chamber fan 310 is turned off to stop the cold air supply (A5).

The first preset temperature of the freezing chamber 300 may be a first set temperature, or a first set temperature range. With regard to the refrigerating chamber 200 too, for convenience' sake, FIG. 4 illustrates only a case when the temperature is controlled based on the first set temperature. However, it is understood that a temperature range for the refrigerating chamber 200 and the freezing chamber 300 may be used. For convenience' sake, FIG. 4 also illustrates only a case when the temperature is controlled, not based on a temperature range, like the first set temperature range, but based on the first set temperature.

If the temperature of the freezing chamber 300 reaches the first set temperature as cold air is being supplied, i.e., when the temperature of the freezing chamber 300 drops below a required level, the supply of cold air from the cold air generating room 600 s i,t freezing chamber fan 310 may be turned off to stop the cold air supply, or the rotation speed of the freezing chamber fan 310 may be varied while keeping the fan 310 operating (A5). By varying the rotation speed, a flow rate of the cold air may also be varied.

Additionally, if the temperature of the freezing chamber 300 reaches the first set temperature, the compressor 20 may be turned off, and the freezing chamber fan 310 may continue to operate for a first set time period (A4). Of course, in this case too, the rotation speed of the freezing chamber fan 310 may be varied. Continued operation of the freezing chamber fan 310 may continue to circulate cold air in the freezing chamber 300 to provide for a more uniform temperature distribution therein.

In order to determine whether the temperature of the freezing chamber 300 reaches the first set temperature, a temperature sensor (not shown) in the freezing chamber 300 may be used. However, the temperature sensed at the temperature sensor may indicate a temperature only at a point where the temperature sensor is mounted, rather than a uniform temperature of entire freezing chamber 300. Therefore, even if the temperature sensed at the temperature sensor reaches the first set temperature, temperatures of other portions of the freezing chamber 300 may not necessarily have reached the first set temperature. Therefore, even after the compressor 20 is turned off, the freezing chamber fan 310 may be operated for a first set time period so as to circulate cold air within the freezing chamber 300 to make the temperature more uniform. In this instance, the temperature sensed at the temperature sensor may change owing to the circulation of the cold air, and, if required, the compressor 20 may be put back into operation to supply additional cold air to the freezing chamber 300.

Second, a case of supplying cold air mainly to the refrigerating chamber 200, without supplying cold air to the freezing chamber 300 (B), will be described.

Since this is a case in which cold air is not required in the freezing chamber 300, the freezing chamber fan 310 is kept turned off (B1). The damper 250 may be operated to keep the refrigerating chamber duct 230 in an opened state, and the refrigerating chamber fan 270 is kept operating (B2). Similar to the case for the freezing chamber 300 described above, the refrigerating chamber 200 may also be kept at a set temperature or within a set temperature range. As described above, for convenience sake, only a case in which control is performed based on a set temperature will be described.

If the temperature of the refrigerating chamber 200 reaches a second set temperature (B3), the refrigerating chamber fan 270 may be turned off (B5). Alternatively, in this instance too, the rotation speed of the refrigerating chamber fan 270 may be varied at this point, while keeping the refrigerating chamber fan 270 in operation (B5).

Alternatively, once the temperature of the refrigerating chamber 200 reaches the second set temperature, the refrigerating chamber fan 270 may be kept operating for a second set time period after the compressor 20 is turned off to circulate cool air in the refrigerating chamber 200 (B4). Of course, in this case too, the rotation speed of the refrigerating chamber fan 270 may be varied. Thus, the compressor 20 may be turned off and the refrigerating chamber fan 270 may kept operating to provide a more uniform distribution of cool air in the refrigerating chamber 200, as described above for the freezing chamber 300.

Next, a case will be described in which cold air is supplied both to the refrigerating chamber 200 and the freezing chamber 300(C).

In this case, both the refrigerating chamber 200 and the freezing chamber 300 require cold air. Therefore, both the refrigerating chamber fan 270 and the freezing chamber fan 310 are kept operating (C1 and C2), and the damper 250 is controlled to open the refrigerating chamber duct 230 (C1).

Since cold air flow rates required by the refrigerating chamber 200 and the freezing chamber 300 may differ, rotation speeds of the refrigerating chamber fan 270 and the freezing chamber 310 may be controlled accordingly. For an example, if a user opens the door 220 and puts a new food item in the refrigerating chamber 200, the temperature of the refrigerating chamber 200 increases, and the refrigerating chamber 200 may require more cold air. This may require the refrigerating chamber fan 270 to have a higher rotation speed than before, while the freezing chamber fan 310 may have a lower or constant rotation speed, depending on the temperature of the freezing chamber 300.

If the temperature of the freezing chamber 300 reaches the first set temperature (C2A1) owing to the supply of cold air, the rotation speed of the freezing chamber fan 310 may be varied or the freezing chamber fan 310 may be turned off (C2A2). Along with this, if the temperature of the refrigerating chamber 200 reaches the second set temperature (C2B1) at the same time, or before, or after the temperature of the freezing chamber 300 reaches the first set temperature (C2A1), the rotation speed of the refrigerating chamber fan 270 may be varied, or the refrigerating chamber fan 270 may be turned off (C2B2). If the refrigerating chamber fan 270 is turned off, the damper 250 may be controlled to close the refrigerating chamber duct 230.

In a case in which both the refrigerating chamber fan 270 and the freezing chamber fan 310 are turned off (C3), the compressor 20 may be turned off, since no cold air supply is required either to the refrigerating chamber 200 or the freezing chamber 300 (C4).

Similarly, in this case too, the refrigerating chamber fan 270 or the freezing chamber fan 310 may be operated while the compressor 20 is turned off to circulate air in the respective chambers.

In a case in which cold air is supplied both to the refrigerating chamber 200 and the freezing chamber 300, the refrigerating chamber fan 270 and the freezing chamber fan 310 may be operated alternately. That is, these components may be controlled such that the refrigerating chamber fan 270 is turned off, the damper 250 is closed, and the freezing chamber fan 310 is kept operating operates for one set time period, and then the freezing chamber fan 310 is turned off, the damper 250 is opened, and the refrigerating chamber fan 270 operates for another set time period. Such alternative operation may be repeated until appropriate temperatures are reached in the chambers.

A requirement for supplying cold air to the freezing chamber 300 and/or the refrigerating chamber 200 (S1) may be determined by various methods, in addition to a chamber temperature sensed by a temperature sensor.

For example, if there is loss of cold air due to the door 320 of the freezing chamber 300 or the door 220 the refrigerating chamber 200 being opened, it may be determined that cold air supply is required based on the opening of the door 220 or 230. That is, if the door 320 of the freezing chamber 300 is opened, the freezing chamber fan 310 may be controlled to supply cold air to the freezing chamber 300 to make up for the loss of cold air. Similarly, if the door 220 of the refrigerating chamber 200 is opened, the refrigerating chamber fan 270 may be controlled to supply cold air to the refrigerating chamber 200.

Alternatively, the requirement for supplying cold air to the freezing chamber 300 or the refrigerating chamber 200 may be determined by measuring a temperature of the freezing chamber 300 or the refrigerating chamber 200. For example, the freezing chamber fan 310 may be controlled to supply cold air to the freezing chamber 300 if the temperature of the freezing chamber 300 exceeds a third set temperature or a third set temperature range. Similarly, the refrigerating chamber fan 270 and the damper 250 may be controlled to supply cold air to the refrigerating chamber 200 if the temperature of the refrigerating chamber 200 exceeds a fourth set temperature or a fourth set temperature range.

The third set temperature or the third set temperature range may be the same as the first set temperature or the first set temperature range, respectively. The fourth set temperature or the fourth set temperature range may be the same as the second set temperature or the second set temperature range, respectively. Similarly, the supply of cold air may be determined based on a set temperature or a set temperature range.

A refrigerator as embodied and broadly described herein has the freezing chamber positioned below the refrigerating chamber. The refrigerating chamber fan and the freezing chamber fan are mounted to the refrigerating chamber duct and the freezing chamber duct respectively, and the damper is provided to open/close the refrigerating chamber duct. By controlling the refrigerating chamber fan, the freezing chamber fan and the damper, cold air is supplied to the refrigerating chamber and the freezing chamber appropriately. Thus, this may be applied to a refrigerator having one evaporator and two fans.

In a refrigerator having one evaporator and only one fan, a cold air supplying operation time may be long, the cold air in the refrigerating chamber may be mixed with the cold air in the freezing chamber, and the cold air supply to the refrigerating chamber and the freezing chamber may not be made independently. This may result in a relatively large variation in temperature and non-uniform cooling of the refrigerating chamber.

Providing two evaporators and two fans may at least partially solve this problem, but at a high cost and use of an inside space of the refrigerating chamber or the freezing chamber, as well as a shortage of refrigerant due to concurrent operation of the two evaporators.

In contrast, a refrigerator and controlling method as embodied and broadly described herein use only one evaporator, so manufacturing cost may be reduced while still improving cooling.

Further, since both the freezing chamber fan and the refrigerating fan may be used together, flow rates may be increased to achieve a fast supply of cold air.

Additionally, because the refrigerating chamber fan and the freezing chamber fan may be operated independently, independent cooling of the refrigerating chamber and the freezing chamber may be achieved.

A bottom freezer type refrigerator having an evaporator, a refrigerating chamber fan, a freezing chamber fan, and a damper for opening/closing a refrigerating chamber duct, and a method for controlling the same, are provided.

A refrigerator as embodied and broadly described herein may include a refrigerating chamber, a freezing chamber under the refrigerating chamber, a compressor for compressing refrigerant, a cold air generating room having an evaporator mounted thereto, a refrigerating chamber duct for making the cold air generating room and the refrigerating chamber in communication, a refrigerating chamber fan mounted to the refrigerating chamber duct, a freezing chamber duct for making the cold air generating room and the freezing chamber in communication, a freezing chamber fan mounted to the freezing chamber duct, and a damper for opening/closing the refrigerating chamber duct.

The refrigerator may also include a controller for controlling the refrigerating chamber fan, the freezing chamber fan, and the damper to supply cold air to the freezing chamber or the refrigerating chamber.

A controlling method for a refrigerator as embodied and broadly described herein may include a determining step for determining supply of cold air to the freezing chamber or the refrigerating chamber, and an air blowing step for controlling the refrigerating chamber fan, the freezing chamber fan, or the damper according to a result of determination for blowing the cold air to the freezing chamber or the refrigerating chamber.

The air blowing step may include the steps of controlling the damper to close the refrigerating chamber duct, and maintaining the refrigerating chamber fan in an off-state, and maintaining the freezing chamber fan in an on-state. This is a case when blowing of the cold air to the refrigerating chamber is not required, and only blowing of the cold air to the freezing chamber is required.

The air blowing step may also include the step of turning off the freezing chamber fan when a temperature of the freezing chamber reaches a first set temperature or is within a first set temperature range.

The temperature control of the freezing chamber may be made with reference to the first set temperature, or the first set temperature range.

The set temperature may be changed at user's input. For example, if freezing of the freezing chamber is controlled in three steps of high-middle-low, if the user selects high, the set temperature may be lower than a case the user selects middle or low.

The air blowing step may also include the step of keeping the freezing chamber fan to be in operation for a first set time period after the compressor is turned off the compressor may be controlled to be turned off when the temperature of the freezing chamber reaches the first set temperature or is within the first set temperature range.

Even when the temperature of the freezing chamber is sensed to reach the first set temperature, the freezing chamber fan may be kept turned on for a first set time period after the compressor has been turned off, since the freezing chamber may not be uniform in temperature. The temperature of the freezing chamber may be sensed with a temperature sensor. An inside temperature of the freezing chamber may differ from location to location, so the temperature sensed through the sensor may be different from one at a location which is apart from the sensor. Therefore, the freezing fan may be kept turned on for circulating the cold air to maintain the freezing chamber at uniform temperature. In this instance, the temperature may be sensed again and re-supply of the cold air to the freezing chamber may be determined. When the re-supply is determined to be required, the compressor and the freezing chamber fan may be controlled to supply the cold air to the freezing chamber, again.

On another hand, when it is determined that the cold air supply to the refrigerating chamber is required, the air blowing step may include the steps of maintaining the freezing chamber fan in an off-state, and controlling the damper to open the refrigerating chamber duct and maintaining the refrigerating chamber in an on-state. This is when cold air supply to the freezing chamber is not required, and only cold air supply to the refrigerating chamber is required.

The air blowing step may also include the steps of turning off the freezing chamber fan when a temperature of the refrigerating chamber reaches a second set temperature or is within a second set temperature range.

A method for controlling the temperature of the refrigerating chamber with reference to the second set temperature or the second set temperature range may be the same as the one for controlling the temperature of the freezing chamber. Similarly, the second set temperature or the second set temperature range may be changed at user's input.

The air blowing step may also include the step of keeping the refrigerating chamber fan to be in operation for a second set time period after the compressor is turned off. The compressor may be turned off when the temperature of the refrigerating chamber is sensed to reach the second set temperature or be within the second set temperature range.

The determining step may include the step of determining whether the temperature of the freezing chamber reaches a third set temperature or is within a third set temperature range, or determining whether the temperature of the refrigerating chamber reaches a fourth set temperature or is within a fourth set temperature range.

The third set temperature or the third set temperature range may be set as the same as the first set temperature or the first set temperature range respectively, and the fourth set temperature or the fourth set temperature range may be set as the same as the second set temperature or the second set temperature range respectively.

For example, though it may be determined that cold air is required to be supplied to the freezing chamber based on a set temperature which is different from the first set temperature, it may also be possible to do so based on the first set temperature.

When both the refrigerating chamber and the freezing chamber require the supply of the cold air, the air blowing step may include the step of controlling the damper to be in an opened state, and keeping both the refrigerating chamber fan and the freezing chamber fan to be in operation.

In this case, the operating of the refrigerating chamber fan and the operating of the freezing chamber fan may be alternated. Namely, the supplies of the cold air to the refrigerating chamber fan and the freezing chamber fan may be alternated. Also, the alternating may be performed based on time. The damper may be controlled to close or open the refrigerating chamber duct during the alternating.

In this instance, the freezing chamber fan may be left turned off when the temperature of the freezing chamber reaches the first set temperature or is within the first set temperature range.

The refrigerating chamber fan may be left turned off when the temperature of the refrigerating chamber reaches the second set temperature or is within the second set temperature range.

The compressor may be left turned off when both the freezing chamber fan and the refrigerating chamber fan are in the off-state.

The rotation speed of the refrigerating chamber fan or the freezing chamber fan may also be varied.

That is, the rotation speed of the freezing chamber fan may be varied depending on whether the temperature of the freezing chamber reaches the first set temperature or is within the first set temperature range, and the rotation speed of the refrigerating chamber fan may be varied depending on whether the temperature of the refrigerating chamber reaches the second set temperature or is within the second set temperature range.

The rotation speeds of the freezing chamber fan and the refrigerating chamber fan may be varied with three levels, high, middle and low.

The refrigerator may include a controller for performing the above controlling method. For this, a control program may be installed in the controller.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a refrigerator having a refrigerating chamber positioned on a freezing chamber and cooled by a compressor and an evaporator positioned in a cold air generating room, a refrigerating chamber fan provided in a refrigerating chamber duct that connects the cold air generating room and the refrigerating chamber, a freezing chamber fan provided in a freezing chamber duct that connects the cold air generating room and the freezing chamber, and a damper that selectively opens and closes the refrigerating chamber duct, the method comprising:
determining whether cold air is required in the freezing chamber or the refrigerating chamber; and
controlling the compressor, the refrigerating chamber fan, the freezing chamber fan and the damper based on a result of the determination to selectively supply cold air to the freezing chamber, to the refrigerating chamber, or to both the refrigerating chamber and the freezing chamber.

2. The method of claim 1, wherein controlling the compressor, the refrigerating chamber fan, the freezing chamber fan and the damper comprises:
controlling the damper to close the refrigerating chamber duct and maintaining the refrigerating chamber fan in an off state;
maintaining the refrigerating chamber fan and the compressor in an on state; and
supplying cold air to the freezing chamber through the freezing chamber duct.

3. The method of claim 2, further comprising turning the compressor off when a temperature of the freezing chamber is less than or equal to a set freezing temperature.

4. The method of claim 3, further comprising turning the freezing chamber fan off when the temperature of the freezing chamber is less than or equal to the set freezing temperature.

5. The method of claim 3, further comprising maintaining the freezing chamber fan an in an on state for a first set time period after the turning the compressor off.

6. The method of claim 5, further comprising varying a rotation speed of the freezing chamber fan during the first set time period.

7. The method of claim 1, wherein controlling the compressor, the refrigerating chamber fan, the freezing chamber fan and the damper comprises:
maintaining the freezing chamber fan an in an off state;
controlling the damper to open the refrigerating chamber duct;
maintaining the compressor and the refrigerating chamber fan in an on state; and
supplying cold air to the refrigerating chamber through the refrigerating chamber duct.

8. The method of claim 7, further comprising turning the compressor off when a temperature of the refrigerating chamber is less than or equal to a set refrigerating temperature.

9. The method of claim 8, further comprising turning the refrigerating chamber fan off when the temperature of the refrigerating chamber is less than or equal to the set refrigerating temperature.

10. The method of claim 8, further comprising maintaining the refrigerating chamber fan an in an on state for a second set time period after the turning the compressor off.

11. The method of claim 10, further comprising varying a rotation speed of the refrigerating chamber fan during the second set time period.

12. The method of claim 1, wherein controlling the compressor, the refrigerating chamber fan, the freezing chamber fan and the damper comprises:
maintaining the freezing chamber fan, the refrigerating chamber fan, and the compressor in an on state;
controlling the damper to open the refrigerating chamber duct; and
supplying cold air to both the refrigerating chamber and the freezing chamber through the refrigerating chamber duct and the refrigerating chamber duct, respectively.

13. The method of claim 12, further comprising:
turning the refrigerating chamber fan off when a temperature of the refrigerating chamber is less than or equal to a set refrigerating temperature; and
turning the freezing chamber fan off when a teperature of the freezing chamber is less than or equal to a set freezing temperature.

14. The method of claim 13, further comprising:
turning the compressor off after both the refrigerating chamber fan and the freezing chamber fan have been turned off.

15. The method of claim 1, wherein controlling the compressor, the refrigerating chamber fan, the freezing chamber fan and the damper comprises:
controlling the damper to close the refrigerating chamber duct and maintaining the refrigerating chamber fan in an off state and the freezing chamber fan in an on state for a first period of time;
after the first period of time has elapsed, controlling the damper to open the refrigerating chamber duct and maintaining the refrigerating chamber fan in an on state and the freezing chamber fan in an off state for a second period of time; and
repeatedly performing the controlling steps until a temperature of the refrigerating chamber is less than or equal to a set refrigerating temperature and a temperature of the freezing chamber is less than or equal to a set freezing temperature.

16. The method of claim 1, wherein controlling the compressor, the refrigerating chamber fan, the freezing chamber fan and the damper comprises:
varying a rotation speed of the refrigerating chamber fan based on a temperature of the refrigerating chamber compared to a preset refrigerating temperature; and
varying a rotation speed of the freezing chamber fan based on a temperature of the freezing chamber compared to a preset freezing temperature.

17. The method of claim 16, wherein the rotation speeds of the freezing chamber fan and the refrigerating chamber fan have three levels.

18. The method of claim 1, wherein controlling the compressor, the refrigerating chamber fan, the freezing chamber fan and the damper comprises controlling the refrigerating chamber fan independently of the freezing chamber fan, and controlling a position of the damper positioned between the refrigerating chamber fan and the freezing chamber fan based on a cold air requirement in the freezing chamber or the refrigerating chamber.

19. A refrigerator, comprising:
a refrigerating chamber;
a freezing chamber;
a compressor that compresses refrigerant;
a cold air generating room having an evaporator provided therein;
a refrigerating chamber duct that connects the cold air generating room to the refrigerating chamber;
a freezing chamber duct that connects the cold air generating room to the freezing chamber;
a refrigerating chamber fan provided in the refrigerating chamber duct;
a freezing chamber fan provided in the freezing chamber duct;
a damper provided in the refrigerating chamber duct so as to selectively open and close the refrigerating chamber duct; and
a controller that controls operation of the compressor, the evaporator, the refrigerating chamber fan, the freezing chamber fan and the damper so as to selectively supply cold air to only the refrigerating chamber, to only the freezing chamber, or to both the refrigerating chamber and the refrigerating chamber.

20. The refrigerator of claim 19, wherein the refrigerating chamber fan and the freezing chamber fan each has a plurality of rotation speeds and are controlled independently, wherein the controller controls the rotation speed of the refrigerating chamber fan based on a temperature of the refrigerating chamber compared to a preset refrigerating temperature, controls the rotation speed of the freezing chamber fan based on a temperature of the freezing chamber compared to a preset freezing temperature, and controls a position of the damper positioned between the refrigerating chamber fan and the freezing chamber fan based on the temperatures of the refrigerating chamber and the freezing chamber compared to the preset refrigerating and freezing temperatures.
